(19) United States
(12) Patent Application Publication
(10) Pub. No.: US 2002/0138473 A1
(43) Pub. Date: Sep. 26, 2002

(54) Preliminary patent prosecution reports

(76) Inventors: Jean E. Whewell, Georgetown, TX (US); Christopher J. Whewell, Georgetown, TX (US)

Correspondence Address: Christopher J. Whewell, Western Patent Group, 6020 Tonkowa Trail, Georgetown, TX, 78628, US

(21) Appl. No.: 09/817,527

(22) Filed: Mar. 26, 2001

(51) Int. Cl. G06F 7/00

(52) U.S. Cl. 707/3

(57) ABSTRACT

The present invention provides patentability search reports and methods for producing same. The search reports of the present invention include a listing of prior art turned up during the course of a patentability search for a proposed invention, in addition to statements pointing out the differences between the features of the proposed invention and those contained in the prior art. However, a report according to the present invention also includes a draft patent claim, which is preferably drafted by a patent Practitioner. By constructing a draft claim, it is possible for the writer of the report to put themselves in the place of a Patent Examiner and make a mock rejection(s) of the draft patent claim based upon the prior art identified during the course of the search. A report according to the invention may include a discussion of the merits of such mock rejections, and rebuttal arguments presented, including suggested means for obviating such mock rejections. Since the report according to a preferred form of the invention contains search results, a draft claim, a mock rejection, and a rebuttal thereto, it is convenient to refer to a report according to the invention as a Preliminary Patent Prosecution Report™.

### BACKGROUND OF THE INVENTION

This invention relates generally to the field of inventions and their patentability, and more particularly to patentability search reports and processes for providing the search reports according to the invention.

Applications for patent to protect inventors' ideas, contrivances, and the like are filed with the United States Patent and Trademark Office and with other patent offices throughout the world. Traditionally, the typical inventor seeks the assistance of a trained patent application draftsperson, either a patent attorney or patent agent (hereinafter “Practitioners”) in the United States or the equivalent in foreign countries, for help in providing a quality patent application to be filed. It is well-known that Practitioners typically charge inventors a substantial amount of money for the services they render, which is directly related to the Practitioner's education, experience, and knowledge in application drafting. Often, the required amount of money exceeds many thousands of dollars and is thus often a significant consideration for inventors seeking to secure patent protection.

In addition to the cost of preparing and filing a patent application, other costs such as government fees and prosecution fees represent significant expenditures for persons seeking to patent inventions. It is not uncommon for the total cost of obtaining a patent on an invention to exceed ten thousand dollars ($10,000.00) in US funds.

Governments have historically defined in their laws certain criteria which must be met in order for patentability of a given proposed invention to be endowed. Typically, the criteria include the requirements that the invention must be: 1) new, over what was previously known to the public; and 2) non-obvious to one of ordinary skill in the art to which the proposed invention is directed. Non-obviousness is often thought of as an aspect of patentability which involves an inventive step. If the criteria for patentability are not met, which may include the prior art containing some teaching or reference teaching various aspects of the invention for which patent protection is sought, then an application for patent may be rejected. Each year, thousands of patent applications filed in the United States alone are abandoned, with no patent ever issuing from such applications.

Thus, there exists a significant chance for the filer of a given patent application that the application will be rejected and all monies, time, and other resources expended in connection with the preparation and filing of the patent application, including development costs, will be wasted. Accordingly, many Practitioners have found it beneficial to conduct or have conducted for them a patentability search prior to the preparation of a patent application on an invention brought to them by a client. A patentability search can be thought of as a survey of the contents of the prior art, in order to determine whether an invention proposed by an inventor actually represents a novel advance over what was already known in the prior art. A patentability search can therefore be used as a criteria upon which a decision may be made to either proceed or not proceed with the filing of a patent application directed at a proposed invention in one or more countries of the world. The use of patentability searches in this way is well-known to Practitioners and other persons.

Since a patentability search is often used to make a business decision upon which great sums of money may hinge, the quality of the patentability search is of utmost importance. This is true because if there is actually prior art in existence which would negate the patentability of a proposed invention, but such prior art is not identified during the patentability search, then the patentability search may give an erroneous impression that such proposed invention is patentable when in fact it is not. In such a case, an inventor would expend resources filing a patent application, only to later find the invention is not patentable and the resources expended were wasted. Therefore, the quality of the patentability search is critical.

Over the years, certain persons have found gainful employment by providing patentability searches to Practitioners and other persons. These certain persons may be regarded as patent searchers, who routinely conduct patentability searches for inventions in all fields of art, or some may specialize in particular fields. patent searchers may employ various means to determine whether a given invention is in fact new over what was previously known, using techniques which are generally well known to patent searchers. These methods include the use of various available databases containing patent data, which are searchable by subject matter and keywords. In addition, many patent searchers elect to conduct searches right at the Patent Office itself, for example, the US Patent and Trademark Office. By conducting the search at the Patent Office, patent searchers have direct access to the same shoes as do the Patent Examiners themselves. Additionally, many patent searchers elect to perform a patentability search using the classification system developed by the Patent Office, which is a system that groups inventions by their subject matter so that a patent searcher may look within a particular class or subclass of interest, as the existence and use of such classes and subclasses are well-known to those in the art of patent searching.

Although the exact methods and procedures used by different patent searchers in conducting a patentability search for determining the scope and contents of the prior art with respect to a proposed invention may differ slightly, a common net result of the work of reputable patent searchers is that in connection with a search performed for determination of patentability of a proposed invention, typically one or more prior art documents will be identified during the course of, or as a result of the search, as being potentially material to the patentability of the proposed invention.

Two of the main criteria upon which patentability of a claimed invention are assessed by Patent Examiners are: 1) the novelty criteria, which under US law is defined by various sections of 35 USC §102; and 2) the non-obviousness criteria, (or inventive-step requirement) which under US law is defined by various sections of 35 USC §103. Thus, during the course of a typical patentability search, a patent searcher may locate various documents in the prior art which may be potentially material to the patentability of the proposed invention in connection for which the search is being conducted. Therefore, a given prior art document may be potentially material to the patentability of a proposed invention from the standpoint of novelty or from the standpoint of non-obviousness. As used in this specification and the appended claims, the words “prior art document” means any printed matter which is accessible by the general public. This term includes without limitation issued patents, journal articles, trade magazine articles, technical bulletins, patent application publications, notes, leaflets, flyers, etc. The answering of the question of whether or not a given prior art document is actually material to the patentability of a proposed invention can only be made by a Patent Examiner or other governmental official, body, or board. During the course of a patentability search, the patent searcher typically only makes a prima facie survey of which documents in the prior art appear to be potentially material to the patentability of the proposed invention. Typically, the patent searcher, in an effort to try to get as much prior art as possible, will cite references and the like which are not actually material to the patentability of the proposed invention, but are only potentially material thereto.

It is a fact that most persons who undertake patent searches are not Practitioners registered to represent inventors before the US Patent and Trademark Office. The laws of supply and demand dictate that persons who conduct patentability searches do not charge as much for the services they render as Practitioners charge their clients. Thus, from an economic standpoint, it would not be expected that a person who undertakes patentability searches would perform services normally rendered by a Practitioner.

Patent claim drafting is a skill which takes practice and time to perfect. According to Practitioner Myron Amer writing in Intellectual Property Today, March 2001 issue: “Claiming is a self-taught art of the most difficult nature. Without intending to demean drafting skills in litigation, a patent practitioner can hone his/her skill in drafting complaints, answers, some motions and like pleadings, by reviewing the “form” file which is maintained by every decent law firm. The same opportunity is not really available in patent claiming, because another's claim by definition involves different facts, otherwise it does not define subject matter that is “unique” and, even more important, the reading process of what someone else has written does not invoke the creativity or intellectual thought process that goes into effective “claiming”.” Thus, the skill of patent claiming is a difficult skill which usually requires years of practice to master reasonably well.

Patent searching, on the other hand, is a skill which may be developed over the relatively short term of time. Learning to search for the novelty of proposed inventions can be generally taught in a day, by explaining to a person the classification system in use in the United States and other various countries. Additionally, keyword searches can be taught in about a day by instructing a person which strings of characters the search engine recognizes. Then, all which is required by the patent searcher is a basic understanding of the proposed invention to be searched.

Upon completion of an exhaustive patentability search for a given proposed invention, a patent searcher or search firm will compile and issue to the inventor or other interested party a report discussing the patentability of the proposed invention. Such patentability search reports in general contain: 1) a listing of the prior art documents turned up during the search; 2) a discussion of each prior art document and its bearing on the patentability of the proposed invention; 3) suggestions as to particular features of the proposed invention which would likely need to be clearly described in any patent application filed which covers the proposed invention; and 4) a general statement in conclusion of the patentability or noon-patentability of the proposed invention. Regrettably, the search reports of the prior art do not give the inventor or search requester any indication as to how the patent claims in a patent application filed on their invention are likely to appear. Further, prior art search reports do not provide the inventor or search requester with any indication of what to expect from a typical Patent Examiner reviewing claims directed at the proposed invention in view of the prior art identified in the patent search. Further, prior art patent searches do not provide any indication to the search requester of how to overcome a rejection which is likely to be made by a Patent Examiner on a claim directed towards the proposed invention. The fact that prior art patentability search reports lack these features is not surprising, since it would not be expected that a person who conducts patent searches would write patent claims directed at a proposed invention in a patentability search report, since patent searchers are not skilled at drafting patent claims and are not familiar with the nature and scope of rejections of claims in pending applications.

### SUMMARY OF THE INVENTION

The present invention provides patentability search reports (a.k.a. “Preliminary Patent Prosecution Report™”) concerning an alleged new invention. A search report according to the invention contains a written evaluation of the patentability of an alleged new invention as compared with at least one prior art document. A patentability search report according to the invention is created prior to the filing of a patent application covering such alleged new invention. A patentability search report according to the invention in its simplest form comprises: a) a citing of one or more prior art documents which contains subject matter that is potentially material to the patentability of the alleged new invention; b) a written description describing the elements or features contained in such one or more prior art documents; and c) at least one written draft patent claim which draft claim embraces a point of novelty of the alleged new invention.

The invention also includes a process for providing a patentability search report concerning an alleged new invention prior to the filing of a patent application covering such alleged new invention, which search report contains a written evaluation of the patentability of the alleged new invention as compared with at least one prior art document. A process according to the invention comprises the steps of: a) reviewing documents contained in the prior art; b) identifying one or more prior art documents that describe subject matter that is potentially material to the patentability of the subject invention; c) providing a written description of the identity of and the elements or features contained in such one or more prior art documents identified in b); and d) providing at least one written draft patent claim, which draft claim embraces a point of novelty of the alleged new invention. In a preferred embodiment, the draft claim is written by a Practitioner.

A process according to the invention may also include the step of providing at least one written statement concerning the patentability of the draft patent claim in view of one or more of the prior art documents cited. Such statement may include a reference to at least one section of either of 35 USC 102 or 35 USC 103.

A process according to the invention may also include the step of formulating a mock rejection of the draft patent claim and providing it in written form. Preferably such mock rejection conforms to the form used by the US Patent and Trademark Office in rejecting patent claims in applications pending before it. Such mock rejection may include a reference to any section of either of 35 USC 102 or 35 USC 103. A process according to the invention may also include the step of providing a written statement describing at least one means for potentially obviating the mock rejection.

### DETAILED DESCRIPTION OF THE INVENTION

A patentability search report according to the invention in its simplest form comprises: a) a citing of one or more prior art documents which contains subject matter that is potentially material to the patentability of the alleged new invention; b) a written description describing the elements or features contained in such one or more prior art documents; and c) at least one written draft patent claim which draft claim embraces a point of novelty of the alleged new invention.

By including a claim which embraces a point of novelty of the proposed invention, a detailed discussion of the patentability of the proposed invention becomes possible. For, once a claim is drafted in written form for inclusion in the patentability search report, the person who wrote the draft claim (who is preferably an experienced Practitioner) may then put themselves in the place of a Patent Examiner, and make written mock rejections in the patentability search report of the draft claim which are based upon the prior art documents identified in the patentability search report, in view of applicable laws, including without limitation statutes such as defined in any section of 35 USC § 102 and 35 USC § 103, and their applicable counterparts when compiling a report according to this invention for jurisdictions foreign to the US. The rejection is called a “mock rejection” because it is not actually official since no patent application has yet been filed, and since it is of no legal effect as it is mere conjecture, since the actions of Patent Examiners cannot in general be predicted with absolute certainty. A report according to the invention also may include one or more statements in rebuttal to the mock rejection or explaining means for overcoming the mock rejection.

Thus, a patentability search report according to the invention may be thought of as a preliminary prosecution report, because it contains a draft claim, a citing of prior art, at least one mock rejection of the draft claim, and a mock rebuttal argument or suggestion of a means for overcoming the mock rejection. A Preliminary Patent Prosecution Report™ according to the invention thus represents a major advance over conventional patentability searches in that it gives the inventor, Practitioner, or other requestor of such report a reasonable idea of the way the prosecution in a patent application that is filed on the proposed invention is likely to fare. Knowing this is believed to be of potential great benefit to the public and government, particularly the US Patent Office, in the event that the Preliminary Patent Prosecution Reports™ of this invention become an industry standard, as they should, as the number of patent applications filed on inventions should be reduced by convincing the requester that: 1) the invention is not likely to be patentable; or 2) the value of a patent issuing on a quality prepared application directed at the invention would be small owing to the narrow scope of coverage available. It is believed that Preliminary Patent Prosecution Reports™ according to the invention have the potential to increase the ratio of issued patents to patents filed in the various patent offices by culling out those inventions not patentable or identifying those of low value as being of such to their owners so that no application is ever filed on them. In any event, it is of value for the search requester to have an understanding of how a Patent Examiner might react to the draft claim in the report.

A report according to the present invention includes a draft patent claim which is directed at the proposed invention for which a patentability search is sought. It is preferred that such draft patent claim is written by a person registered to represent inventors before the United States Patent and Trademark Office, although it is conceivable and within the scope of this invention that other persons may be capable of drafting such a draft claim. It is preferred that the person writing the draft claim be a Practitioner because it is believed that Practitioners generally write claims of the highest quality, and which claims are most likely to be deemed patentable by a patent-issuing authority when drafted in view of the known prior art.

It is also preferred that a report according to the invention include one or more written statements pointing out the differences between the elements or features contained in one or more of the prior art documents identified during a patentability search and the proposed invention, as defined by the draft patent claim. Such written statements may include reference to any section of either 35 USC §102 of 35 USC §103. It is of great value to have a draft patent claim included in the report having a claim directed at the proposed invention gives the writer of the report a concrete definition of the proposed invention against which to adjudge patentability of the proposed invention, as compared to prior art methods and patentability search reports which only acknowledged the description of the proposed invention in vague and nebulous terms, often citing the general nature of the invention and its use or function, and pointing out the features of the proposed invention and the elements and features of the prior art.

It is most preferred that the draft patent claim included in a report according to this invention be not properly rejectable under any section of either 35 USC §102 of 35 USC §103 according to the standards used in evaluating patentability currently in practice at the time of this writing at the United States Patent and Trademark Office, as set forth in the Manual of Patenting Procedure (“MPEP”), which manual is herein incorporated in its entirety by reference thereto. However, in the events that such standards are changed, it will still be most preferred that such draft claim included in a report according to this invention be not properly rejectable under any section of either 35 USC §102 of 35 USC §103 according to the standards in use at such time.

It is also preferred that a report according to the invention include one or more written statements reflecting an opinion about the patentability of the proposed invention as described in the draft patent claim in view of the prior art documents cited in such report. Such opinion may include reference to any section of either 35 USC §102 of 35 USC §103.

It is also preferred that a report according to the invention include one or more mock rejections of the draft patent claim in view of the prior art documents cited in such report. Such mock rejections may include reference to any section of either 35 USC §102 of 35 USC §103. A mock rejection included in a report according to the invention preferably conforms substantially to the format used by the United States Patent and Trademark Office (or other patent-issuing authority) in rejecting patent claims in applications pending before it. Thus such mock rejection(s) may include form paragraphs commonly used by Patent Examiners, as set forth in the MPEP, or may be a paraphrasing thereof Such mock rejections may also be of the form used in the past in any rejection contained in any file wrapper of any issued US patent available to the public, all of which are herein incorporated by reference for U.S. Pat. Nos. 3,000,000 to 6,000,000 including every patent therebetween, or may be a paraphrasing thereof The main criteria is that communication is made to the requester of the search report of a type of rejection often encountered during patent prosecution, and that such type of rejection may be applicable to the draft claim (or any draft claim, when a report according to the invention contains a plurality of draft claims) if such were included in an application filed with a patent office or patent-issuing authority such as the United States Patent and Trademark Office or any of its equivalent agencies in countries foreign to the United States. It is preferred, but not necessary, that a mock rejection in a report according to the invention be written by a person registered to represent inventors before the United States Patent and Trademark Office or other patent-issuing authority.

Thus, one typical mock rejection included in a report according to the invention might take the form: “Claim 1 describes a widget useful in shaping wood products comprising elements A, B, and C. Reference '007 describes a widget useful in shaping wood products comprising elements A and B. Reference '008 describes a widget useful in shaping wood products comprising elements B and C and thus having element C in a wood shaping widget is deemed to be generally known in the art. Therefore, it would have been obvious to one skilled in the art to include element C in a wood shaping widget.” Thus claim 1 is rejected under 35 USC 103(a) as being obvious.

Another typical mock rejection included in a report according to the invention might take, as but one form: “Claim 1 describes a widget useful in shaping wood products comprising elements A, B, and C. Reference '010 describes a widget useful in shaping die cast zinc products comprising elements A, B, and C. Each element of applicant's claimed invention is disclosed in the single prior art reference '010. Thus, claim 1 is rejected under 35 USC 102(b) as being anticipated by '010.”

It is also preferred that a report according to the invention include one or more written rebuttals or discussions concerning the merits of the mock rejection of the draft patent claim in view of the prior art documents cited in such report. Such rebuttal or discussion may include reference to any section of either 35 USC §102 of 35 USC §103. Such rebuttal or discussion may also include statements as to why the rejection(s) made in the mock rejection are inapplicable to the proposed invention or may include statements which describe means for overcoming such rejections, if ever made, such as showing commercial success, unexpected results, or other reasons given in the MPEP as being bona fide reasons for overcoming various possible rejections.

Thus, one rebuttal included in a report according to the invention might take the form: “Although reference '007 describes a widget useful in shaping wood products comprising elements A and B, and reference '008 describes a widget useful in shaping wood products comprising elements B and C, there exists no teaching, motivation, or suggestion in the art of any beneficial reason for inclusion of element C in combination with A and B, as is required for a proper prima facie case of obviousness to be made. Therefore, the rejection under 35 USC 103(a) should not be applicable.”

It matters not what the subject matter is for an alleged new invention for which a search report according to the invention is desired by a requester. A report according to the invention may be concerned with articles of manufacture, processes, compositions of matter, machines, methods of doing business, designs, plants, or any other subject matter for which patents are issuable.

I claim:

1) A patentability search report concerning an alleged new invention, which search report contains a written evaluation of the patentability of such alleged new invention as compared with at least one prior art document, and wherein such search report is created prior to the filing of a patent application covering such alleged new invention, said patentability search report comprising:
a) a citing of one or more prior art documents which contains subject matter that is potentially material to the patentability of the alleged new invention;
b) a written description describing the elements or features contained in such one or more prior art documents; and
c) at least one written draft patent claim which draft claim embraces a point of novelty of the alleged new invention.

2) A patent search report according to claim 1 wherein said draft patent claim is written by a person registered to represent inventors before the United States Patent and Trademark Office.

3) A patent search report according to claim 1 wherein said draft patent claim is not properly rejectable under any section of either 35 USC §102 of 35 USC § 103 in view of any of said prior art documents.

4) A patent search report according to claim 1 wherein said draft patent claim is in a claim format acceptable to the United States Patent and Trademark Office.

5) A patent search report according to claim 1 comprising a plurality of draft patent claims.

6) A patentability search report according to claim 1 further comprising: d) one or more written statements pointing out the differences between the elements or features contained in one or more of said prior art documents and the alleged new invention as described by said draft patent claim.

7) A patentability search report according to claim 1 further comprising: d) a written statement reflecting an opinion about the patentability of the alleged new invention as described in said draft patent claim in view of the prior art documents cited.

8) A patentability search report according to claim 7 wherein said written statement includes a statement in reference to any section of 35 USC § 102.

9) A patentability search report according to claim 7 wherein said written statement includes a statement in reference to any section of 35 USC § 103.

10) A patentability search report according to claim 6 further comprising: e) a written mock rejection of said draft patent claim.

11) A patentability search report according to claim 10 wherein said mock rejection conforms substantially to the form used by the United States Patent and Trademark Office in rejecting patent claims in applications pending before it.

12) A patentability search report according to claim 10 wherein said mock rejection is written by a person registered to represent inventors before the United States Patent and Trademark Office.

13) A patentability search report according to claim 10 wherein said mock rejection includes a statement in reference to any section of 35 USC § 102.

14) A patentability search report according to claim 10 wherein said mock rejection includes a statement in reference to any section of 35 USC § 103.

15) A patentability search report according to claim 10 further comprising: f) a written statement describing at least one means for potentially obviating said mock rejection.

16) A patentability search report according to claim 1 wherein one or more prior art documents cited describe subject matter selected from the group consisting of: a) an article of manufacture; b) a process: c) a composition of matter; d) a machine; and e) a method of doing business.

17) A patentability search report according to claim 1 wherein said alleged new invention is an invention which falls within the statutory classes of patentable subject matter selected from the group consisting of: a) an article of manufacture; b) a process: c) a composition of matter; d) a machine; and e) a method of doing business.

18) A patentability search report concerning an alleged new invention, which search report contains a written evaluation of the patentability of said alleged new invention as compared with at least one prior art document, and wherein the search report is created prior to the filing of a patent application covering said alleged new invention, said patentability search report comprising:
a) a citing of one or more prior art documents which contains subject matter that is potentially material to the patentability of the alleged new invention;
b) a written description describing the elements or features contained in such one or more prior art documents;
c) at least one written draft patent claim which draft claim embraces a point of novelty of the alleged new invention, wherein said draft patent claim is written by a person registered to represent inventors before the United States Patent and Trademark Office;
d) a written mock rejection of said draft patent claim, which mock rejection is based at least in part on the presence or arrangement of elements or features contained in at least one of said prior art documents in said citing, wherein said mock rejection is written by a person registered to represent inventors before the United States Patent and Trademark Office.

19) A patent search report according to claim 18 wherein said draft patent claim is not properly rejectable under any section of either 35 USC §102 of 35 USC § 103 in view of any of said prior art documents.

20) A patent search report according to claim 18 wherein said draft patent claim is in a claim format acceptable to the United States Patent and Trademark Office.

21) A patentability search report as in claim 18 and further comprising: e) a written statement describing at least one means for potentially obviating said mock rejection.

22) A patentability search report concerning an alleged new invention, which search report contains a written evaluation of the patentability of said alleged new invention as compared with at least one prior art document, and wherein the search report is created prior to the filing of a patent application covering said alleged new invention, said patentability search report comprising:
a) a citing of one or more prior art documents which contains subject matter that is potentially material to the patentability of the alleged new invention;
b) a written description describing the elements or features contained in such one or more prior art documents;
c) at least one written draft patent claim directed at the subject matter of said alleged new invention which draft claim embraces a point of novelty of the alleged new invention;
d) one or more written statements pointing out the differences between the elements or features contained in one or more of said prior art documents and the alleged new invention as described by said draft patent claim; and
e) a written statement reflecting an opinion about the patentability of the alleged new invention as described by said draft patent claim.

23) A patentability search report according to claim 22 and further comprising:
f) a written mock rejection of said draft patent claim, which mock rejection is based at least in part on the presence or arrangement of elements or features contained in at least one of said prior art documents in said citing.

24) A patentability search report as in claim 23 and further comprising:
g) a written statement describing at least one means for potentially obviating said mock rejection.

25) A patent search report according to claim 23 wherein said draft patent claim is not properly rejectable under any section of either 35 USC §102 of 35 USC § 103 in view of any of said prior art documents.

26) A patent search report according to claim 23 wherein said draft patent claim is in a claim format acceptable to the United States Patent and Trademark Office.

27) A process for providing a patentability search report concerning an alleged new invention prior to the filing of a patent application covering such alleged new invention, which search report contains a written evaluation of the patentability of the alleged new invention as compared with at least one prior art document, the process comprising the steps of:
a) reviewing documents contained in the prior art;
b) identifying one or more prior art documents that describe subject matter that is potentially material to the patentability of the subject invention;
c) providing a written description of the identity of and the elements or features contained in such one or more prior art documents identified in b); and
d) providing at least one written draft patent claim, which draft claim embraces a point of novelty of the alleged new invention.

28) A process according to claim 27 wherein said draft patent claim is written by a person registered to represent inventors before the United States Patent and Trademark Office.

29) A process according to claim 27 further comprising the step of e) providing at least one written statement concerning the patentability of said draft patent claim in view of said one or more prior art documents identified.

30) A process according to claim 29 wherein said written statement includes a statement in reference to at least one section of 35 USC § 102.

31) A process according to claim 29 wherein said written statement includes a statement in reference to at least one section of 35 USC § 103.

32) A process according to claim 29 further comprising the steps of: f) formulating a mock rejection of said draft patent claim; and g) providing said mock rejection in written form.

33) A process according to claim 32 wherein said mock rejection conforms substantially to the form used by the United States patent and Trademark office in rejecting patent claims in applications pending before it.

34) A process according to claim 32 wherein said mock rejection is a rejection under any section of 35 USC § 102.

35) A process according to claim 32 wherein said mock rejection is a rejection under any section of 35 USC § 103.

36) A process according to claim 32 further comprising the step of: h) providing a written statement describing at least one means for potentially obviating said mock rejection.
